(19) United States
(12) Patent Application Publication
(10) Pub. No.: US 2007/0060174 A1
(43) Pub. Date: Mar. 15, 2007

(54) Methods, systems, and computer program products for updating message routing profiles

(75) Inventors: Gregory Newton, Dunwoody, GA (US); John Ruckart, Atlanta, GA (US)

Correspondence Address: MYERS BIGEL SIBLEY & SAJOVEC, P.A., P.O. BOX 37428, RALEIGH, NC, 27627, US

(73) Assignee: BellSouth Intellectual Property Corporation

(21) Appl. No.: 11/322,639

(22) Filed: Dec. 30, 2005

Related U.S. Application Data
(60) Provisional application No. 60/717,301, filed on Sep. 15, 2005.

(51) Int. Cl. H04Q 7/20

(52) U.S. Cl. 455/456.5

(57) ABSTRACT

A method of providing communications can include updating a message routing profile for a subscriber responsive to location associated information received from a communications device proximate to the subscriber.

### CROSS REFERENCE RELATED APPLICATION

This Application is related to and claims the priority of U.S. Provisional Patent Application Ser. No. 60/717,301, filed Sep. 15, 2005, entitled Systems and Methods for Managing Profile Information, the disclosure of which is hereby incorporated herein by reference.

### FIELD OF THE INVENTION

The present invention generally relates to the field of electronic communications.

### BACKGROUND

A wide variety of means exist for communication between users. For example, a user may be contacted via a home phone, work phone, mobile phone etc. In addition, users may also communicate using devices such as PC's, PDA's, pagers, etc. using, for example, email and instant messaging.

Managing such a wide variety of communications for these devices can be difficult, such as, when a user changes location. For example, while traveling, it may only be possible to reach a user via the user's mobile phone. However, the user may best be reached by email while at work. Also, the user may wish to implement various rules for receiving and controlling communications. For example, to be reached at home, the user may want the home phone to ring three times before forwarding the call to a mobile phone. As another example, the user may wish to be paged each time an email is received from a particular person while away from the office, all of which may be unknown to those who wish to contact the user.

### SUMMARY

Embodiments according to the invention can provide methods, systems, and computer program products for updating communication device profiles. Pursuant to these embodiments, a method of providing communications can include updating a message routing profile for a subscriber responsive to location associated information received from a communications device proximate to the subscriber. In some embodiments according to the invention, updating further includes receiving location device data associated information at the communications device from a location device as the subscriber changes location. A message including at least a portion of the location associated information, based on the location device data, is forwarded to a message routing profile manager. The message routing profile is updated for the subscriber to include the at least the portion of the location associated information included in the message.

In some embodiments according to the invention, updating a message routing profile includes updating a location identifier for the message routing profile, a message device type associated with the location identifier, a status for the message device, and/or subscriber status associated with the location identifier. In some embodiments according to the invention, subscriber status is do not disturb status, a communications type based do not disturb status, and/or an originator based do not disturb status.

In some embodiments according to the invention, updating subscriber status further includes determining subscriber status based on information in a calendar application associated with the subscriber. In some embodiments according to the invention, updating further includes determining whether to update the location identifier based on a location device identifier or if the location assistance information is within a range of a location for a message routing profile.

In some embodiments according to the invention, receiving location device data at the communications device from a location device includes receiving the location device data at the communications device from an RFID tag transmitter, a Global Positioning System, a Local Area Network (LAN), and/or a communications system location assistance transmitter.

In some embodiments according to the invention, forwarding a message includes forwarding the message including the at least the portion of the location associated information via a TCP/IP Session Initiation Protocol (SIP) message, a SS7 (Signaling System 7) message, a common channel SS7 message, an in-band signaling message, and/or a Short Message Service (SMS) message. In some embodiments according to the invention, forwarding a message includes forwarding the message via a cellular telephone network, a Public Switched telephone network (PSTN), Internet, and/or a LAN.

In some embodiments according to the invention, a system to provide communications includes a message routing profile manager configured to update a message routing profile for a subscriber responsive to location associated information received from a communications device proximate to the subscriber. In some embodiments according to the invention, the message routing profile manager is further configured to receive location device data at the communications device from a location device as the subscriber changes location, receive a message including at least a portion of the location associated information, based on the location device data, forwarded from the communications device, and update the message routing profile for the communications device to include the at least the portion of the location associated information included in the message.

In some embodiments according to the invention, the message routing profile manager is further configured to update a location identifier for the message routing profile, a communications device type associated with the location identifier, a status for the communications device, and/or subscriber status associated with the location identifier.

In some embodiments according to the invention, a method for providing communications using an Internet based message routing profile manager includes receiving first location associated information in a first message at an Internet based message routing profile manager forwarded by a first communications device as a subscriber changes location to a first location. A location identifier is updated to be a first location identifier for a message routing profile associated with the first location. Messages are routed to a first subscriber device associated with the first location identifier. Second location associated information is received in a second message at the Internet based message routing profile manager forwarded by a second communications device as the subscriber changes location to a second location. The location identifier for the message routing profile is updated to be a second location identifier associated with the second location. Messages are routed to a second subscriber device associated with the second location identifier.

### BRIEF DESCRIPTION OF THE DRAWINGS

FIG. 1 is a schematic illustration of a system configured to update a subscriber message routing profile according to some embodiments of the invention.

FIG. 2 is a schematic illustration of a subscriber message routing profile according to some embodiments of the invention.

FIGS. 3-7 are schematic illustrations of communication devices configured to receive location device data from location devices and forward messages including location associated information according to some embodiments of the invention.

FIG. 8 is a schematic illustration depicting the updating of a subscriber message routing profile as a subscriber changes location according to some embodiments of the invention.

FIG. 9 is a block diagram that illustrates a system configured to operate a subscriber message routing profile manager to update a subscriber message routing profile according to some embodiments of the invention.

### DESCRIPTION OF THE EMBODIMENTS ACCORDING TO THE INVENTION

The present invention now is described more fully hereinafter with reference to the accompanying figures, in which embodiments of the invention are shown. This invention may, however, be embodied in many alternate forms and should not be construed as limited to the embodiments set forth herein. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

It will be understood that, when an element is referred to as being “coupled” to another element, it can be directly coupled to the other element or intervening elements may be present. In contrast, when an element is referred to as being “directly coupled” to another element, there are no intervening elements present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense expressly so defined herein.

The present invention is described below with reference to diagrams (such as schematic illustrations) and/or operational illustrations of methods, devices, and computer program products according to embodiments of the invention. It is to be understood that the functions/acts noted in the figures may occur out of the order noted in the operational illustrations. For example, two elements shown in succession may in fact be executed substantially concurrently or the elements may sometimes be executed in the reverse order, depending upon the functionality/acts involved.

The present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM).

Computer program code or “code” for carrying out operations according to the present invention may be written in an object oriented programming language such as JAVA®, Smalltalk or C++, JavaScript, Visual Basic, TSQL, Perl, or in various other programming languages. Software embodiments of the present invention do not depend on implementation with a particular programming language. Portions of the code may execute entirely on one or more systems utilized by an intermediary server.

The computer program code may be provided to a processor of a general purpose computer, special purpose computer, or other programmable data processing apparatus as instructions to produce a machine, such that the instructions, which execute via the processor of the computer or other programmable data processing apparatus, create means for implementing the functions specified in the illustrations.

The computer code may be stored in a computer-readable memory that can direct a computer or other programmable data processing apparatus to function in a particular manner, such that the instructions stored in the computer-readable memory produce an article of manufacture including instruction means which implement the function specified in the illustrations.

It will be understood that at least a portion of the communications described herein can be provided according to Session Initiation Protocol (SIP), which is described in more detail in, for example, “Internet Communications Using SIP,” by Henry Sinnreich, ISBN: 0-471-41399-2. Internet Protocol communications are generally described in, for example, “TCP/IP Protocol Suite,” by Behrouz A Forouzan, ISBN: 0-07-119962-4. Moreover, techniques for the creation and operation of virtual communities, is described in, for example, “Design for Community: The Art of Connecting Real People in Virtual Places,” by Derek M. Powazek, ISBN: 0-7357-1075-9. The content these references is incorporated herein by reference.

The communications used for forwarding the messages to the profile manager may be provided using an Internet Protocol (IP) Multimedia Subsystem (IMS). IMS can utilize a packet switched domain (such as the Internet) to transport multimedia signaling and bearer traffic. The message forwarding may be provided, for example, via a Universal Mobile Telecommunication System (UMTS) to access multimedia services of IMS. IP Multimedia Systems are discussed in each of the following: (1) 3GPP TS 22.228 entitled “Service Requirements for the IP Multimedia Core Network Subsystems”; (2) 3GPP TS 23.228 entitled “IP Multimedia Subsystems”; and (3) 3GPP TR 22.941 entitled “IP Based Multimedia Services Framework.” The subject matter of each of these references is hereby incorporated by reference.

It will be understood that messages can be provided via a TCP/IP Session Initiation Protocol (SIP) message, a SS7 (Signaling System 7) message, a common channel signaling message, an in-band signaling message, and/or a Short Message Service (SMS) message, an Enhanced Message Service (EMS) message, a Multimedia Message Service (MMS) message, and/or Smartmessaging™ message. As is known to those skilled in the art, SMS and EMS messages can be transmitted on digital networks, such as GSM networks, allowing relatively small text messages (for example, 160 characters in size) to be sent and received via a network operator's message center to the user device, or via the Internet, using a so-called SMS (or EMS) “gateway.”

As described hereinbelow in greater detail, embodiments according to the invention can allow a subscriber message routing profile to be updated as the subscriber moves from one location to another. In particular, as the subscriber moves, location devices can provide location data to a communication device proximate to the subscriber (such as a cellular telephone). The communications device can, in turn, forward a message including location associated information to a subscriber message routing profile manager which can determine whether to update the subscriber's message routing profile based on the subscriber's new location. The updated profile may then affect how (or whether) messages are routed to the subscriber in the new location.

For example, in some embodiments according to the invention, when a subscriber leaves home in the morning an RFID transmitter located in the subscriber's car can provide location device data to the subscriber's cellular telephone (equipped with an RFID receiver). The subscriber's cellular telephone may then forward a message, via the wireless network that services the cellular telephone, to a subscriber message routing profile manager located on the Internet. The profile manager can determine whether to update the subscriber's message routing profile based on the detected presence of the subscriber in the car. For example, the updated profile for the subscriber in the car may specify that only urgent messages are to be routed to the subscriber's cellular telephone or, alternatively, that only messages from certain originators are to be routed to the subscriber's cellular telephone while the subscriber is in the car.

In other embodiments according to the invention, the communication device may receive Global Positioning System (GPS) data, as the location device data, from a GPS satellite. The GPS data is used by the communication device (equipped with a GPS receiver) to determine an approximate location for the communication device (and implicitly for the subscriber). The communication device may then forward a message to the profile manager to determine whether the subscriber's message routing profile should be updated based on the GPS data. In still other embodiments according to the invention, the communications device may be configured to receive location device data from a wireless network (such as a cellular telephone network or a local area network) to determine an approximate location for the communications device.

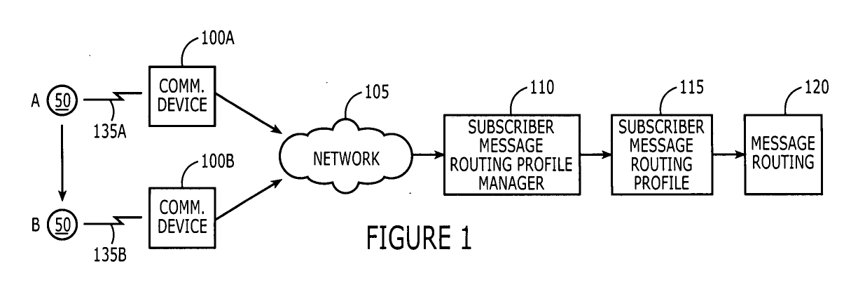

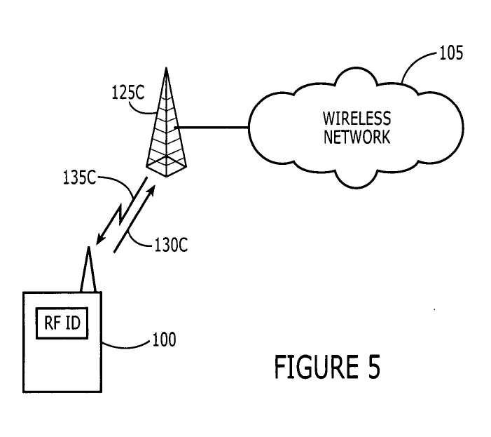

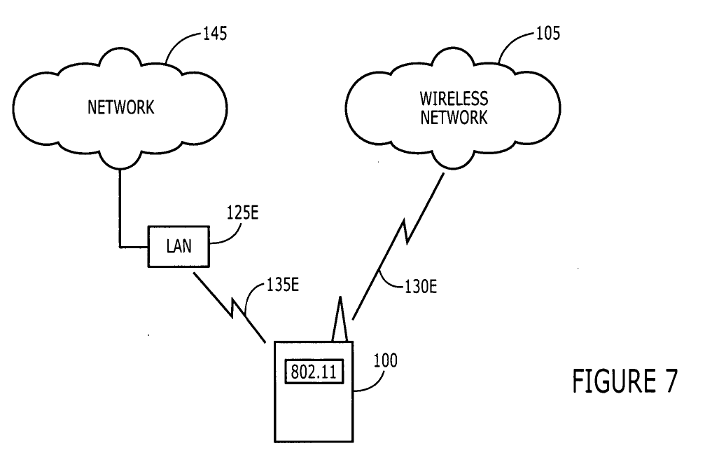

FIG. 1 is a schematic illustration of a system including a subscriber message routing profile manager 110 (profile manager) that is configured to receive messages including location associated information that can indicate the location of a subscriber so that the subscriber's message routing profile 115 (routing profile) may be updated to control message routing 120 according to some embodiments of the invention. In particular, as shown in FIG. 1, a subscriber 50 is initially positioned at a location A so that a communication device 100A receives location device data 135A from a location device associated with the subscriber 50. For example, in some embodiments according to the invention, the subscriber may carry a device that includes a Radio Frequency Identifier (RFID) transmitter that transmits a unique code to the communication device 100A. In other embodiments according to the invention, the location device may be a GPS that provides GPS data used to calculate the approximate location at a GPS receiver. In still other embodiments according to the invention, the location device can be a portion of a network that provides data to the communications device used to determine a location associated with the subscriber 50 as described herein below in greater detail in reference to FIGS. 5 and 7.

Referring to FIG. 1, upon receiving the location device data 135A, the communication device 100A forwards a message to the subscriber message routing profile manager 110 via a network 105. The message includes location associated information that indicates a location for the subscriber 50 in the location A. In some embodiments according to the invention, the profile manager 110 provides a routing profile 115 to control the routing of messages to a subscriber's device based on the location for the subscriber 50 in the location A. It will be understood that the network 105 can be a Public Switched Telephone Network (PSTN), a Voice over IP (VoIP) network (such as the Internet), a wireless network used to provide cellular telephone service, a wireless local area network such as an 802.11 compliant network, or the like.

As the subscriber 50 moves to location B, a communication device 100B receives location device data associated with the subscriber 50 (e.g., from the same device as in location A) in the new location B. The communication device 100B forwards a message to the subscriber message routing profile manager 110 via the network 105 as described above in reference to the communication device 100A. The profile manager 110 determines whether to update the routing profile 115 to reflect the new location B where the subscriber is now positioned.

In some embodiments according to the invention, the profile manager may load an entirely new profile as the updated profile in response to the new location. In other embodiments according to the invention, only a portion of the existing profile 115 may be updated to reflect, for example, a new status of the subscriber. Accordingly, some updated profiles may result in messages being routed to new devices associated with the subscriber while in other embodiments, the status of the device or of the subscriber may be changed while the device itself remains as part of the updated profile 115.

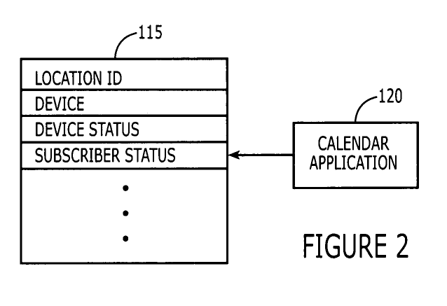

FIG. 2 is a schematic illustration of the subscriber message routing profile 115 according to some embodiments of the invention. In particular, as shown in FIG. 2, the profile 115 can include a plurality of parameters that specify how messages are to be routed to a subscriber based on the location associated information received by the subscriber message routing profile manager 110 as shown in FIG. 1.

The plurality of parameters included in the subscriber message routing profile 115 can include a location identifier (ID) that corresponds to the location in which the subscriber is positioned according to the location associated information received from the communication device in communication with the respective location device. For example, in some embodiments according to the invention, the location ID may indicate the subscriber is located in the subscriber's car based on a unique ID encoded in an RFID transmitter attached to the car.

A device type included in the subscriber message routing profile 115 can provide information related to the subscriber's device, such as a telephone number, as well as what types of messages are supported by the device (e.g., voice, text etc.) when the corresponding routing profile 115 is active. For example, as described above, when location associated information, which indicates that the subscriber is now in the car, is provided to the profile manager 110, the profile 115 may be updated with the location ID associated with the subscriber's car and, therefore, the device type is updated to be the subscriber's cellular telephone number or, alternatively, the subscriber's car phone which may hard wired into the car.

Other types of devices include a single or dual mode cellular telephone with or without an internal GPS receiver; a Voice over IP telephone (VoIP); a Personal Communications System (PCS) terminal that may combine a cellular telephone with data processing, facsimile and data communications capabilities; a Personal Data Assistant (PDA) that can include a mobile terminal, pager, Internet/intranet access, Web browser, organizer, calendar, a conventional laptop and/or palmtop computer.

The device type may be also used to indicate whether the format of a message should be translated before being routed to the subscriber under the current profile. For example, if the profile 115 indicates that the device type is a pager, messages routed to the subscriber's device (i.e., the pager) should be in a text format. Accordingly, any audio or other type message formats could be translated to text before being routed to the subscriber's pager. The subscriber message routing profile 115 can also include a device status which indicates whether the device (identified as device type above) is on or off, thereby indicating whether messages should be routed to the subscriber's device under the current profile 115.

The subscriber message routing profile 115 can also include a subscriber status that indicates whether the subscriber is, for example, currently receiving messages. In some embodiments according to the invention, the subscriber status can be set to “Do Not Disturb” (DND) status wherein no messages will be routed to the subscriber's device. In other embodiments according to the invention, the subscriber status may be a communication type DND wherein messages may be routed to the subscriber's device based on, for example, the urgency or importance of the message. In still further embodiments according to the invention, the subscriber status may be an originator based DND wherein messages may be routed to the subscriber's device based on the identity of the message originator. For example, if a message is originated by the subscriber's supervisor, the subscriber status may allow the message to be routed to the subscriber's device whereas if the originator is unknown or included in a black list, the message may be blocked from routing to the subscriber's device.

In still further embodiments according to the invention, the subscriber status may be based at least partially on input from a calendar application 120 associated with the subscriber. For example, the profile 115 may include a subscriber status that indicates that all messages except for those originated by those listed as attendees to an upcoming meeting listed in the subscriber's calendar application 120 should be blocked. In other embodiments according to the invention, the calendar 120 may indicate that the subscriber is “out-of-Office” or on vacation. It will be understood that other parameters may also be included in the subscriber message routing profile 115.

Referring still to FIGS. 1 and 2, as the subscriber 50 moves from one location to another, location device data is received by the communication devices 100 that are operatively coupled to one or more networks which may access the subscriber message routine profile manager 110, which may update the profile currently being used to route messages to the subscriber 50.

Accordingly, the determination as to whether the profile 115 is to be updated can be based on the location device ID and/or the proximity of the location associated information to a location which is known by the profile manager 110. For example, the profile manager 110 may determine to update the profile 115 upon receiving location associated information from a communication device that includes an RFID tag that uniquely identifies a known location in the subscriber's office. Therefore, the subscriber message routine profile manager 110 can update the profile 115 so that subsequent messages are routed to a telephone located near the subscriber based on the RFID tag provided as the location device data.

If the location device data does not identify a known location, but rather represents “raw geographic location data,” such as GPS data, the profile manager 110 may determine to update the profile 115 if the location indicated by the GPS data is near enough to an otherwise known location. For example, if the location data provided by a GPS satellite indicates that the subscriber 50 has entered a conference room in the subscriber's office, the profile 115 can be updated to route all subsequent messages to a telephone in that conference room.

It will be understood that updating the subscriber message routing profile 115 can, as described above, involve routing messages to different subscriber devices. It will further be understood that updating the routing profile 115 may also change other parameters included in the routing profile 115 without changing the device type. For example, the profile manager 110 may update the routing profile 115 so that the device type remains the same, but the device status and/or the subscriber status is changed. In some embodiments according to the invention, the subscriber may carry a cellular telephone for an entire day where the device status and subscriber status parameters are continually changed based on the locations visited by the subscriber 50. The subscriber may carry the cellular telephone into a movie theater whereupon the profile manager 110 updates the routing profile 115 to change the device status to “off.” In a further example, the subscriber may carry the cellular telephone to their home for dinner whereupon the profile manager 110 may update the routing profile 115 to change the subscriber status to DND until dinner time has passed. Alternatively, the subscriber status may be changed based on the calendar application data described above in reference to FIG. 2. Accordingly, updating the routing profile 115 may not result in messages being routed to different devices but rather result in the status of the device and/or the subscriber being updated.

It will be understood that although the routing profile can be updated essentially automatically as the subscriber moves, the routing profile may also be accessed via, for example, the Internet so that an authorized user can control the application of the routing profiles. For example, a parent may be designated as a manager for a child's routing profile so that the parent may specify that the status of the child's device is “off” during school or study time and/or locations. Accordingly, the routing profiles may be organized hierarchically.

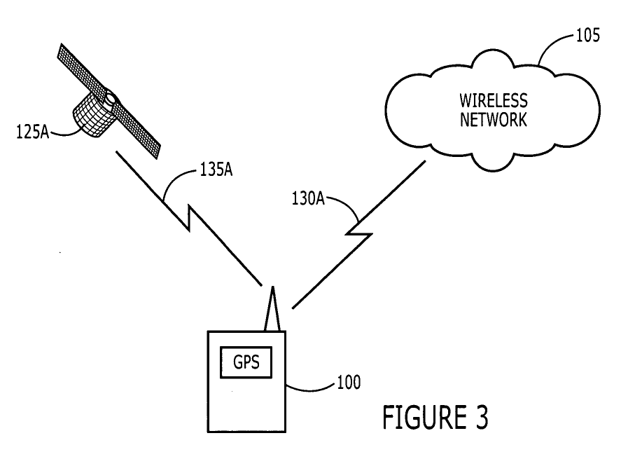

FIG. 3 is a schematic illustration of a communication device 100 including a GPS receiver according to some embodiments of the invention. In particular, a GPS system 125A, as the location device, provides GPS data 135A as the location device data to the communication device 100 including the GPS receiver. The communication device 100 uses the GPS data 135 received from the GPS system 125A to determine an approximate location for the communication device 100. The communication device 100 then forwards a message including location associated information 130A to the wireless network 105 that can otherwise provide service to the communication device 100. The location associated information 130A included in the message can be provided to the profile manager 110 which determines whether to update the profile for the subscriber based on the location associated information 130A.

FIG. 3 is a schematic illustration of a communication device configured to receive location device data from a GPS satellite 125A and forward messages including location associated information according to some embodiments of the invention. It will be understood that the communication device 100 shown in FIG. 3 is used therein to provide the location associated information 130A to the profile manager 110 based on the device location data provided by the GPS satellite 125A, but is not necessarily the device to which messages are routed according to the profile 115. In other words, the communication device 100 may be used to provide the location associated information 130A to the profile manager 110 because the communication device 100 is in communication with the wireless network 105 and therefore may provide a convenient way for messages to be forwarded to the profile manager 110. Once the message is provided to the profile manager 110, the profile manager 110 may update the profile 115 to route messages to a different device associated with the subscriber, such as a desk telephone, computer or other device).

As will be appreciated by those skilled in the art, the communication device 100 may determine a location using the GPS data using a GPS receiver circuit, that uses, for example, any available GPS or assisted GPS based location approach in conjunction with a GPS satellite system 274. Such approaches are commonly referred to as assisted-GPS, which is defined, for example, in specification numbers 3GPP TS 04.31, 3GPP TS 03.71 and 3GPP TS 04.35. Assisted-GPS approaches are also discussed, for example, in U.S. Pat. Nos. 4,445,118, and 5,418,538, and 5,663,734, and 5,663,735, and 6,433,735, and in published US Patent Application No. US 2003/0011511 A1, the disclosures of which are hereby incorporated herein by reference.

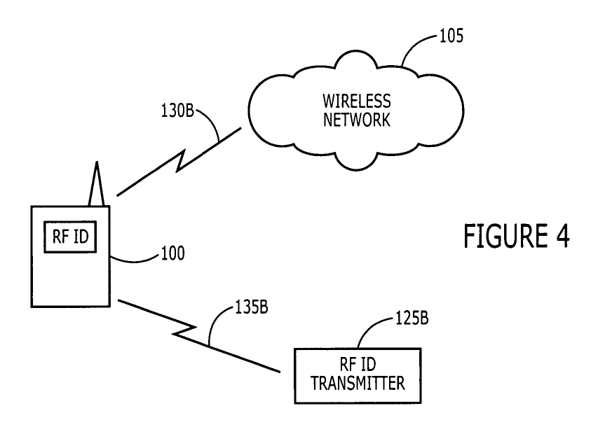

FIG. 4 is a schematic illustration of the communication device 100 in communication with the wireless network 105 to provide the location associated information 130B according to some embodiments of the invention. According to FIG. 4, the communication device 100 includes an RFID receiver that is configured to receive a transmission 135B from an RFID transmitter 125B as the location device data. It will be understood that the location device data 135B transmitted by the RFID transmitter 125B can include a unique code that identifies the RFID transmitter 125B and, consequently, the location of the communication device 100 (if the location of RFID transmitter 125B is accessible to the profile manager 110). For example, the identity (i.e., tag) of the RFID transmitter 125 may identify a fixed location such as an office or building or may identify a setting, such as the interior of a car, etc.

According to FIG. 4, the communication device 100 forwards a message including location associated information 130B which can include data included in the location device data 135B received from the RFID transmitter 125B. The profile manager 110 receives the message from the communication device 100 and updates the profile 115 based on a change in the location of the subscriber indicated by the location associated information 130B, whereupon messages can be routed to the subscriber in accordance with the new parameters in the updated profile 115.

It will be appreciated by those skilled in the art that Radio Frequency Identification (RFID) refers to the use of low-cost “tags” embedded in or attached to items and store “bar code” type information, as well as more detailed information about the items. The tags are generally small labels, or the like, with a miniature embedded antenna. A tag reader (sometimes referred to herein as an RFID receiver) interrogates the tag by transmitting an RFID signal, which energizes the embedded antenna to provide power for the tag to transmit a responsive RFID signal to the reader.

FIG. 5 is a schematic illustration of the communications device 100 serviced by the wireless network 105 including a base station 125C that collectively serve as the location device according to some embodiments of the invention. In particular, the communication device 100 can receive signals from the base station 125 that can provide the location device data 135C upon which the location of the communication device 100 may be based. For example, the communication device 100 can include circuits and software that enable the communication device 100 to determine an approximate location for the communication device 100. The determined location can be forwarded in a message to the profile manager 110 that includes the location associated information 130C. The profile manager 110 may update the subscriber profile 115 on the basis of the location associated information 130C included in the message whereupon messages can be routed to the subscriber in accordance with the updated profile 115.

It will be understood that although the base station 125C shown in FIG. 5 is described as providing the location device according to some embodiments of the invention, the location device data provided to the communication device 100 can be determined using other components of the wireless network 105. For example, the locations of the base stations in a communications network are known to the service provider, and may be provided to a cellular telephone as an approximate location of the subscriber. Such a combination of components can be collectively referred to as a communications system location assistance transmitter.

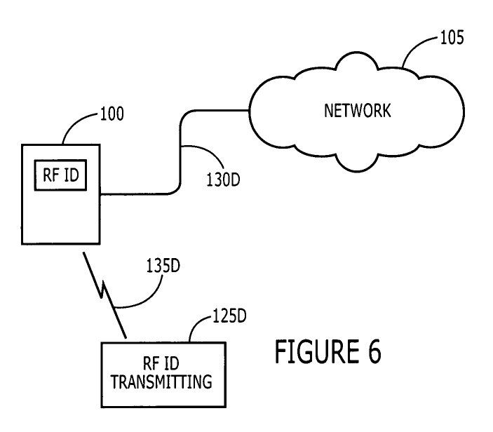

FIG. 6 is a schematic illustration of a communication device 100 connected to a network 140 via a land line according to some embodiments of the invention. In particular, an RFID transmitter 125D serves as the location device which transmits location device data 135D to a communication device 100 which includes an RFID receiver. The communication device 100 can forward the location device information 135D as part of a message including location associated information that indicates, for example, a unique identifier associated with the RFID transmitter 125D.

The message is received by the profile manager 110 which can determine whether to update the profile 115 based on the location associated information 130D included in the message. For example, the profile manager 110 may compare the identifier included in the location associated information 130D that identifies the location of the RFID transmitter 125D so that the profile 115 can be updated to reflect the subscriber's new location. Subsequently, messages can be routed to the subscriber in accordance with the updated profile.

It will be understood that the network 140 can be a PSTN or other type of network capable of carrying voice and/or multimedia communications such as the Internet. Alternatively, the network 140 may be a corporate or private Wide Area Network where the communication device 100 is a VoIP compatible telephone.

FIG. 7 is a schematic illustration of a communication device 100 that communicates with a network access point 125E connected to a network 145 and communicates with the wireless network 105 according to some embodiments of the invention. In particular, the communication device 100 receives location device data 135E from the network access point 125E in accordance with an IEEE 802.11 compliant interface included in the communication device 100.

It will be understood that the network access point 125E can be considered part of the network 145 which can, in conjunction therewith, provide data to indicate the approximate location of the network access point 125E as part of the location device data 135E. The communication device 100 forwards a message to the profile manager 110 including the location associated information 130E which can include the location device data 135E provided by the network access point 125E and network 145. The profile manager 110 can determine whether to update the profile 115 based on the location associated information 130E included in the message so that subsequent messages can be routed to the subscriber according to the updated profile 115.

It will be understood that the location device data 135E provided by the network access point 125E can be provided by a combination of resources in the network 145 in conjunction with the network access point 125E as well as other network access points not shown. In some embodiments according to the invention, the network 145 can be an “ad hoc” network, such as a Bluetooth compliant network, that is coupled to another network through which the location device data may be provided. As used herein, an “ad hoc” protocol network or transmitter refers to one that is generally configured at the time of use based on the resources available. Such networks, typically, provide a service discovery protocol to allow, for example, identification of available resources. They may also negotiate various aspects of operations, such as peer relationships between resources, at the time of use of the resources. The Bluetooth™ interface is further described in an article authored by Jaap Haartsen entitled Bluetooth—The universal radio interface for ad hoc, wireless connectivity, Ericsson Review, No. 3, 1998, which is hereby incorporated herein by reference in its entirety.

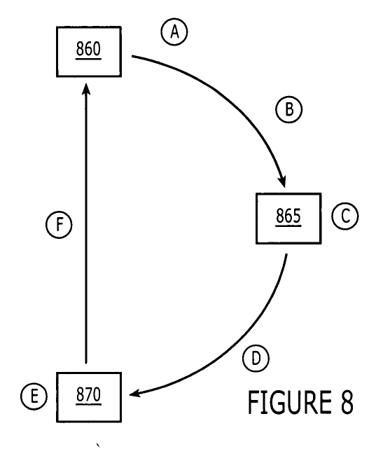

FIG. 8 is a schematic illustration of an exemplary embodiment depicting operations of systems and methods for updating a message routing profile according to some embodiments of the invention. Referring to FIG. 8, a subscriber begins a particular day at a home 860 having a routine profile A associated therewith. In particular, the routing profile A specifies that messages are to be routed to a home telephone at home 860. The profile further specifies that the device status is “on,” however, the subscriber status indicates that only high priority calls are to actually be routed to the home telephone at home 860. Accordingly, only high priority messages will be routed to the home telephone under routing profile A.

At a later time, the subscriber begins commuting to work using a car that includes an RFID transmitter which uniquely identifies the subscriber's car as the location of the RFID transmitter. When the subscriber begins the commute, the RFID transmitter transmits the location device data to the subscriber's cellular telephone, which in turn forwards a message to the profile manager 110. The profile manager 110 then determines that the subscriber has changed locations and, therefore, updates the profile to routing profile B. Routing profile B, specifies the cellular telephone as the device to which messages (such as calls or text messages), however, the subscriber's status is changed under profile B to allow lower priority messages to be routed to the subscriber's cellular telephone during the subscriber's commute.

When the subscriber arrives at a work location 865, the cellular telephone receives location device data from localized RFID transmitters reflecting the subscriber's movement within the work location 865. Accordingly, the messages received at the profile manager 110 reflect the subscriber's movements throughout the work location 865, which causes the routing profile to be changed to routing profile C. In accordance with routing profile C, the device type is changed to various desk phones located within the workplace 865 corresponding to locations visited by the subscriber. Furthermore, the subscriber status may also be changed as the day passes and as the subscriber moves between different settings within the workplace 865 which may call for different subscriber status.

Later, the subscriber leaves the workplace 865 to travel to restaurant 870. En route, the subscriber's cellular telephone receives transmissions from the RFID transmitter located in the subscriber's car, which is forwarded to the profile manager 110. The profile manager 110 updates the routing profile to profile D based on the subscriber's presence in the car as well as on a calendar application associated with the subscriber indicating a lunchtime appointment with several attendees. Accordingly, the profile allows messages to be routed to the cellular telephone if the messages are originated from any of the scheduled attendees of the lunch meeting.

Upon arrival at the restaurant 870, the profile may again be changed to turn the device status to “off” so that no messages are routed to the subscriber during the meeting. Alternatively, the device status may remain in the “on” state while the subscriber status is changed to block any messages except those originating from those who had been scheduled to attend the lunchtime via telephone.

Later, the subscriber begins the commute to home 860 whereupon the cellular telephone again receives location device data from the RFID transmitter in the subscriber's car. The cellular telephone transmits a message to the profile manager 110, whereupon the profile manager may again update the routing profile 115 to profile F which specifies that only high priority messages are to be routed to the cellular telephone. After arriving at the home 860, the profile may again be changed to profile G (based on data from the calendar application associated with the subscriber) so that, as the evening progresses, only higher priority messages will be routed to the subscriber's device.

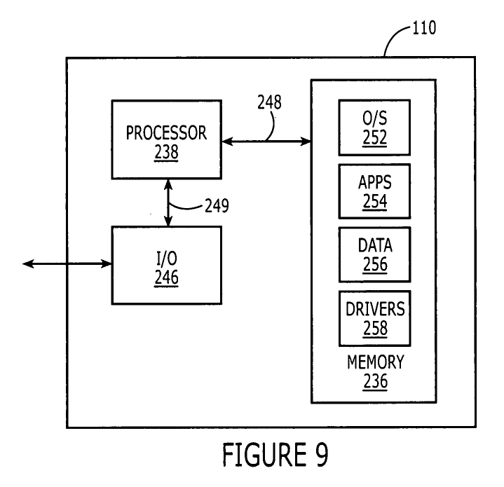

FIG. 9 is a block diagram of an exemplary profile manager 110 configured to update a message routing profile in some embodiments according to the invention. As illustrated, the profile manager 110 includes a processor 238, a memory 236 and input/output (I/O) circuits 246. The profile manager 110 may be incorporated in, for example, a general purpose computer, server, or the like. The processor 238 communicates with the memory 236 via an address/data bus 248 and communicates with the input/output circuits 246 via an address/data bus 249.

The profile manager 110 is coupled to the network 105 through the input/output circuits 246 using, for example, an Internet Protocol (IP) connection to receive messages from the communications device 100 including the location associated information.

The components in the profile manager 110 may be known components such as those used in many data processing systems, which may be configured to operate as described herein. In particular, the processor 238 can be any commercially available or custom microprocessor, microcontroller, digital signal processor or the like. The memory 236 may include any memory devices containing the software and data used to implement the functionality circuits or modules used in accordance with embodiments of the present invention. The memory 236 can include, but is not limited to, the following types of devices: cache, ROM, PROM, EPROM, EEPROM, flash memory, SRAM, DRAM and magnetic disk.

As further illustrated in FIG. 9, the memory 236 may include several categories of software to provide operation of the profile manager 110: an operating system 252; application programs 254 including the software to provide the operations of the profile manager described herein, translation between message formats, input/output device drivers 258; and data 256.

In some embodiments according to the invention, the applications software 254 can convert messages to/from various formats so that the routing of messages may provide more suitable formatting when a message to be routed is not in the “native” format of the subscriber device to which the message is to be routed. For example, the system used to route the messages to the subscriber device may include a text to voice conversion function that allows the conversion of incoming email messages to audio which can then be forwarded for delivery to a voice based user device, such as a PSTN telephone, a VoIP telephone, voicemail, etc. Furthermore, the system can include software to convert voice based messages to text, such as to convert a voice message to an email message that is forwarded.

The data 256 represents the static and dynamic data used by the application programs 254, the operating system 252, and the input/output device drivers 258, that may reside in the memory 236. The data 56 can include the the different profiles to be used and the profile parameters included therein, RFID tags associated with know locations, etc. as described herein.

As will be appreciated by those of skill in the art, the operating system 252 may be any operating system suitable for use with a data processing system, such as OS/2, AIX or zOS from International Business Machines Corporation, Armonk, N.Y., Windows 95, Windows98, Windows2000 or WindowsXP from Microsoft Corporation, Redmond, Wash., Unix or Linux.

The input/output device drivers 258 typically include software routines accessed through the operating system 252 by the application programs 254 to communicate with devices such as the input/output circuits 246 and the memory 236.

In the drawings and specification, there have been disclosed embodiments of the invention and, although specific terms are employed, they are used in a generic and descriptive sense only and not for purposes of limitation, the scope of the invention being set forth in the following claims.

What is claimed:

1. A method of providing communications comprising:
updating a message routing profile for a subscriber responsive to location associated information received from a communications device proximate to the subscriber.

2. A method according to claim 1 wherein updating further comprises:
receiving location device data associated information at the communications device from a location device as the subscriber changes location;
forwarding a message including at least a portion of the location associated information, based on the location device data, to a message routing profile manager; and
updating the message routing profile for the subscriber to include the at least the portion of the location associated information included in the message.

3. A method according to claim 1 wherein updating a message routing profile comprises updating a location identifier for the message routing profile, a message device type associated with the location identifier, a status for the message device, and/or subscriber status associated with the location identifier.

4. A method according to claim 3 wherein subscriber status comprises do not disturb status, a communications type based do not disturb status, and/or an originator based do not disturb status.

5. A method according to claim 3 wherein updating subscriber status further comprises:
determining subscriber status based on information in a calendar application associated with the subscriber.

6. A method according to claim 3 wherein updating further comprises:
determining whether to update the location identifier based on a location device identifier or if the location assistance information is within a range of a location for a message routing profile.

7. A method according to claim 2 wherein receiving location device data at the communications device from a location device comprises receiving the location device data at the communications device from an RFID tag transmitter, a Global Positioning System, a Local Area Network (LAN), and/or a communications system location assistance transmitter.

8. A method according to claim 7 wherein forwarding a message comprises forwarding the message including the at least the portion of the location associated information via a TCP/IP Session Initiation Protocol (SIP) message, a SS7 (Signaling System 7) message, a common channel SS7 message, an in-band signaling message, and/or a Short Message Service (SMS) message.

9. A method according to claim 8 wherein forwarding a message comprises forwarding the message via a cellular telephone network, a Public Switched telephone network (PSTN), Internet, and/or a LAN.

10. A method according to claim 1 embodied in a computer program product comprising a computer readable medium having computer readable program code embodied therein.

11. A system to provide communications comprising:
a message routing profile manager configured to update a message routing profile for a subscriber responsive to location associated information received from a communications device proximate to the subscriber.

12. A system according to claim 11 wherein the message routing profile manager is further configured to:
receive location device data at the communications device from a location device as the subscriber changes location;
receive a message including at least a portion of the location associated information, based on the location device data, forwarded from the communications device; and
update the message routing profile for the communications device to include the at least the portion of the location associated information included in the message.

13. A system according to claim 11 wherein the message routing profile manager is further configured to:
update a location identifier for the message routing profile, a communications device type associated with the location identifier, a status for the communications device, and/or subscriber status associated with the location identifier.

14. A system according to claim 13 wherein subscriber status comprises do not disturb status, a communications type based do not disturb status, and/or an originator based do not disturb status.

15. A system according to claim 13 wherein the message routing profile manager is further configured to determine subscriber status based on information in a calendar application associated with the subscriber.

16. A system according to claim 13 wherein the message routing profile manager is further configured to determine whether to update the location identifier based on a location device identifier or if the location assistance information is within a range of a location for an predetermined message routing profile.

17. A system according to claim 12 wherein the location device data is received at the communications device from an RFID tag transmitter, a Global Positioning System, a Local Area Network (LAN), and/or a communications system location assistance transmitter.

18. A system according to claim 17 wherein the message routing profile manager is further configured to receive a message including the at least the portion of the location associated information via a TCP/IP Session Initiation Protocol (SIP) message, a SS7 (Signaling System 7) message, a common channel SS7 message, an in-band signaling message, and/or a Short Message Service (SMS) message.

19. A system according to claim 18 wherein the message routing profile manager is further configured to receive the message via a cellular telephone network, a Public Switched telephone network (PSTN), Internet, and/or a LAN.

20. A method for providing communications using an Internet based message routing profile manager, the method comprising:
receiving first location associated information in a first message at an Internet based message routing profile manager forwarded by a first communications device as a subscriber changes location to a first location;
updating a location identifier to be a first location identifier for a message routing profile associated with the first location;
routing messages to a first subscriber device associated with the first location identifier;
receiving second location associated information in a second message at the Internet based message routing profile manager forwarded by a second communications device as the subscriber changes location to a second location;
updating the location identifier for the message routing profile to be a second location identifier associated with the second location; and
routing messages to a second subscriber device associated with the second location identifier.
